(19) United States
(12) Patent Application Publication
(10) Pub. No.: US 2018/0273174 A1
(43) Pub. Date: Sep. 27, 2018

(54) DISPOSABLE AIR VEHICLE AND METHOD OF DELIVERING AID

(71) Applicant: Windhorse Aerospace Limited, Yeovil, Somerset (GB)

(72) Inventor: Nigel Frank Gifford, Wells, Somerset (GB)

(73) Assignee: Windhorse Aersospace Limited, Yeovil, Somerset (GB)

(21) Appl. No.: 15/781,930

(22) PCT Filed: Dec. 6, 2016
(86) PCT No.: PCT/GB2016/053842

§ 371 Date: Jun. 6, 2018

(30) Foreign Application Priority Data
Dec. 7, 2015 (GB) 1521502.3

(51) Int. Cl. B64C 39/02; B64D 9/00; B64C 3/18; B64C 1/06

(52) U.S. Cl. CPC B64C 39/024; B64D 9/00; B64C 2201/128; B64C 1/061; B64C 3/18

(57) ABSTRACT

An unmanned disposable air vehicle (1) comprising a structural part (3) that has an outer structure (17) and an inner structure (15) located inside the outer structure (17), the inner structure (15) being arranged to support the outer structure (17), wherein at least one of the inner structure (15) and outer structure (17) comprises an article of aid (19) such that the air vehicle (1) may be flown to a relief zone and the structural part (3) dismantled from the air vehicle (1) to allow the article of aid (19) to be used.

### FIELD OF THE INVENTION

The present invention relates to a disposable air vehicle for delivering aid to a relief zone.

The present invention relates particularly, but not exclusively, to an unmanned disposable air vehicle for delivering aid to a relief zone.

The present invention also relates to a structural part of a disposable air vehicle for delivering aid to a relief zone.

The present invention also relates to a method of delivering aid to a relief zone using a disposable air vehicle.

The present invention also relates to a method of assembly of a disposable air vehicle for delivering aid to a relief zone.

### BACKGROUND OF THE INVENTION

In order to deliver aid to a relief zone by air, for example a disaster zone, it is necessary for a manned aircraft (e.g. a cargo plane or transport helicopter) carrying aid cargo to be flown to a relief zone, to land the aircraft in the relief zone, unload the cargo from the aircraft and then have the aircraft take-off and return to its origin (in order to pick up more aid cargo).

A problem with this is that it requires a landing site in the relief zone suitable for relatively large cargo aircraft to land, and then unload. Often in a relief zone there is no suitable landing site, and any suitable site is a long distance away from where the relief is needed.

In addition, the amount of cargo that such cargo aircraft can carry is limited by the space available in the cargo hold of the aircraft.

Furthermore, the cost of using such cargo aircraft is relatively high.

The present invention seeks to address or mitigate at least some of the above mentioned problems.

The present invention also seeks to provide an improved or alternative disposable air vehicle for delivering aid. The present invention also seeks to provide an improved or alternative structural part of a disposable air vehicle for delivering aid. The present invention also seeks to provide an improved or alternative method of delivering aid to a relief zone. The present invention also seeks to provide an improved or alternative method of assembly of a disposable air vehicle for delivering aid.

### SUMMARY OF THE INVENTION

According to a first aspect of the invention there is provided an unmanned disposable air vehicle comprising a structural part that has an outer structure and an inner structure located inside the outer structure, the inner structure being arranged to support the outer structure, wherein at least one of the inner structure and outer structure comprises an article of aid such that the air vehicle may be flown to a relief zone and the structural part dismantled from the air vehicle to allow the article of aid to be used.

This may be advantageous in that it allows an unmanned disposable air vehicle to be used to deliver a greater amount of aid to a relief zone than would otherwise be possible (by the unmanned air vehicle). In this respect, the amount of aid that the air vehicle can deliver is not limited by an internal cargo space, for example in a fuselage of the air vehicle, since one or more structural components of the air vehicle may comprise an article of aid.

This may provide a relatively efficient way of delivering aid since on or more components of the aircraft may be used to provide aid.

The use of an unmanned air vehicle to deliver aid may be advantageous in that unmanned air vehicles can land in smaller landing sites and with less preparation of the landing site (if any) than conventional cargo aircraft. This may allow aid to be delivered closer to a target location in a relief zone, than would otherwise be possible.

The cost of using the unmanned disposable air vehicle may be relatively low, compared to conventional cargo aircraft.

In an embodiment of the invention the inner structure is of greater rigidity than the outer structure.

In an embodiment of the invention the inner structure is arranged such that it increases the rigidity of the outer structure.

In an embodiment of the invention the outer structure is flexible.

Optionally the at least one of the inner structure and outer structure comprises a single article of aid.

For example, where the inner structure comprises the article of aid, the article of aid may be a single block of food, a frozen liquid, medical aid or solid fuel, for example. Where the outer structure comprises the article of aid, the article of aid may be a single film of a foodstuff, for example.

In an embodiment of the invention the at least one of the inner and outer structure is formed by the article of aid. In an embodiment of the invention the at least one of the inner and outer structure consists of the article of aid.

In an embodiment of the invention the structural part is a load-bearing structural part of the air vehicle.

Optionally the article of aid is arranged such that a load applied to the structural part is transmitted through the structural part.

The article of aid may be arranged to transmit an applied load between opposed ends of the structural part.

The article of aid may be arranged to transmit an applied load substantially along the length, width and/or thickness of the structural part.

In an embodiment of the invention the inner structure is a load bearing part of the structural part. 2 0 Where the inner structure comprises the article of aid, the article of aid may be arranged such that a load applied to the inner structure is transmitted through the inner structure.

In an embodiment of the invention the outer structure is a load bearing part of the structural part.

Where the outer structure comprises the article of aid, the article of aid may be arranged such that a load applied to the outer structure is transmitted through the outer structure.

The applied load may be due to aerodynamic forces on the structural part when the air vehicle is in flight. The applied load may be due to forces exerted on the structural part when the air vehicle is on the ground, including when stationary or when taxiing.

The applied load may be a shearing force, bending moment and/or twisting moment.

Optionally the at least one of the inner structure and outer structure comprises a plurality of articles of aid.

For example, where the inner structure comprises the articles of aid, the articles of aid may be a plurality of blocks of food, frozen liquid, medical aid and/or or solid fuel, for example. Where the outer structure comprises the articles of aid, the articles of aid may be a plurality of films of one or more foodstuffs, for example.

In an embodiment of the invention the at least one of the inner and outer structure is formed by the articles of aid. In an embodiment of the invention the at least one of the inner and outer structure consists of the articles of aid.

Optionally the articles of aid are arranged such that a load applied to the structural part is transmitted through the structural part.

Adjacent articles of aid may be attached to each other, to provide rigidity to the structure.

The articles of aid may be arranged to transmit an applied load between opposed ends of the structural part.

The articles of aid may be arranged to transmit an applied load substantially along the length, width and/or thickness of the structural part.

Where the inner structure comprises the articles of aid, the articles of aid may be arranged such that a load applied to the inner structure is transmitted through the inner structure.

Where the outer structure comprises the articles of aid, the articles of aid may be arranged such that a load applied to the outer structure is transmitted through the outer structure.

Optionally the articles of aid are arranged to form an array of articles such that a load applied to the structural part is transmitted through the array of articles.

The array of articles may be a chain of articles. The chain of articles may be arranged to transmit the load along the length of the chain. The chain of articles may be straight, curved, or part-curved along its length. In this case, the array may be regarded as a ‘one-dimensional ’ array.

The array of articles may form a two dimensional grid of articles. In this case, the array of articles may be arranged to transmit the load along one or both dimensions of the grid.

The array of articles may be a three dimensional array of articles. In this case, the array of articles may be arranged to transmit the load along one, two or three dimensions of the array.

Articles in the array that are adjacent to each other may be in contact with each other so as to transmit the load along the array.

Articles adjacent to each other in the array may be attached to each other, to provide rigidity to the array.

Articles in the array that are adjacent to each other may be separated by an intermediary member arranged to transmit the load between adjacent articles.

In an embodiment of the invention, where the inner structure comprises the articles of aid, the array formed by the articles of aid is more rigid than the outer structure.

In an embodiment of the invention the article of aid, or the array formed by the plurality of articles, is sufficiently rigid such that the structural part is able to withstand the forces exerted on it throughout the operational envelope of the air vehicle.

In an embodiment of the invention the, or each, article of aid is for providing a secondary function in addition to a primary function as a structural part of the air vehicle. The secondary function may be to provide food, drink, fuel and/or medicine, for example.

Optionally the, or each, article of aid is solid. In this respect, the, or each, article of aid may be a frozen liquid. For example, the, or each, article of aid may be water frozen as ice.

Optionally the, or each, article of aid is biodegradable.

Optionally the, or each, article of aid is disposable.

Optionally the inner and/or outer structure is biodegradable and/or disposable.

Optionally the other of the at least one of the inner structure and outer structure is biodegradable and/or disposable.

Optionally one or more structural components of the air vehicle is biodegradable and/or disposable.

Optionally the, or each, article of aid is compressed.

Optionally the, or each, article of aid is a foodstuff and/or is drinkable. Optionally the, or each, article of aid is a compressed foodstuff.

The, or each, article of aid may comprise, or consist of solid fuel.

The, or each, article of aid may comprise, or consist of medical equipment or drugs.

The, or each, article of aid may comprise, or consist of a film of material. The film may be of a foodstuff. For example the, or each, article of aid, may comprise, or consist of, a film of gelatine or a seaweed film derivative.

Optionally where the outer structure comprises the article of aid, the article of aid is said film of material.

Where there are a plurality of articles of aid, the articles of aid may be different forms of aid.

Optionally the inner structure comprises the, or each, article of aid.

Optionally the outer structure does not comprise the, or each, article of aid. Alternatively, the outer structure may also comprise one or more articles of aid.

Optionally the outer structure comprises the, or each, article of aid. Optionally the inner structure does not comprise the, or each, article of aid. Alternatively, the inner structure may also comprise one or more articles of aid.

The structural part may be a structural part of an airframe of the air vehicle.

Alternatively, or additionally, the structural part may be a structural part of a propulsion system of the air vehicle.

Optionally the structural part is a wing.

The wing may be a lifting and/or or control surface of the air vehicle. For example the wing may be a lifting wing, a wing of a tail, for example a horizontal or vertical stabiliser, an aileron, an elevator, a rudder and/or a flap.

The wing may be a winglet. The winglet may be provided at a tip of a wing of the air vehicle.

The wing may be a fixed wing.

The wing may be a rotary wing. In this case, the structural part may be part of a propulsion system of the air vehicle.

Where the inner structure comprises the article(s) of aid, the inner structure may consist of the, or each, article of aid.

Optionally the inner structure is a support structure of the wing. The support structure may be for supporting a skin of a wing. The support structure may be a stringer, spar, rib and/or dihedral of the wing.

Where the inner structure comprises the article(s) of aid, the, or each, article of aid may be contained within a cover such that the cover and the, or each, article of aid, form the inner structure.

Optionally the outer structure is a skin of the wing. It will be appreciated that the skin of the wing is the outer skin of the wing that contacts the oncoming air during flight.

Optionally the structural part is a fuselage.

Optionally the outer structure is a skin of the fuselage. It will be appreciated that the skin of the fuselage is the outer skin of the fuselage that contacts the oncoming air during flight.

Where the inner structure comprises the article(s) of aid, the inner structure may consist of the, or each, article of aid.

Optionally the inner structure is a support structure of the fuselage. The support structure may be for supporting a skin of the fuselage. The support structure may be a stringer, spar, frame rib and/or bulkhead of the fuselage.

Where the inner structure comprises the article(s) of aid, the, or each, article of aid may be contained within a cover such that the cover and the, or each, article of aid, form the inner structure.

Optionally the structural part is a support structure of a wing of the air vehicle.

The support structure may be for supporting a skin of the wing. The support structure may be a stringer, spar, rib and/or dihedral of the wing, for example.

Where the inner structure comprises the article(s) of aid, the inner structure may consist of the, or each, article of aid.

The outer structure may be a cover arranged to contain the, inner structure. The cover may form a substantially closed enclosure around the, or each, article of aid. The cover may be openable and closable. The, or each, article may be vacuum packed in the cover. The cover may be a sleeve. The cover may be thermoformed. The cover may be 3D printed.

Where the outer structure comprises the article(s) of aid, the, or each article of aid may be a film of material. The film may be of a foodstuff. The film may be, for example, a gelatine film of a film of a seaweed derivative.

Optionally the structural part is a support structure of a fuselage.

The support structure may be arranged to support a skin of a fuselage. The support structure may be a spar, stringer, bulkhead, frame, rib, or former, for example.

Where the inner structure comprises the article(s) of aid, the inner structure may consist of the, or each, article of aid.

The outer structure may be a cover arranged to contain the, inner structure. The outer structure may be a cover arranged to contain the, inner structure. The cover may form a substantially closed enclosure around the, or each, article of aid. The cover may be openable and closable. The, or each, article may be vacuum packed in the cover. The cover may be a sleeve.

Where the outer structure comprises the article(s) of aid, the, or each article of aid may be a film of material. The film may be of a foodstuff. The film may be, for example, a gelatine film of a film of a seaweed derivative.

Optionally the structural part forms one or more cargo compartments.

The cargo compartments may be for receiving one or more aid articles, for use as aid.

Optionally the structural part is an undercarriage of the air vehicle.

The outer structure may be an outer surface of the undercarriage. The inner structure may be a support structure of the undercarriage. The support structure may be strut, rib or spar of the undercarriage, for example.

The undercarriage may be a wheeled structure for supporting the air vehicle.

The undercarriage may be a sled, or one or more skis, for supporting the air vehicle.

The structural part may be a housing for a system of the air vehicle. The system may be a navigation system and/or power system. The navigation system may be, for example, a global positioning system. The power system may be, for example, an electrical battery or generator.

The inner structure may be a housing body for receiving the navigation system and/or power system.

The outer structure may be sealed closed.

The outer structure may be heat sealed closed.

Optionally the, or each, article is vacuum packed in the outer structure.

In this regard, there may be substantially no air between the, or each, article and the outer structure.

The outer structure may retain the, or each, article of aid in its position.

The outer structure may be made of a plastic material. The outer structure may be made of polyethylene.

Optionally the structural part may be dismantled from the air vehicle by dismantling the at least one of the inner and outer structure from the air vehicle. In this respect, the other of the at least one of the inner and outer structure may remain part of the air vehicle. Alternatively, the structural part may be dismantled from the air vehicle by dismantling both the inner and outer structure from the air vehicle.

Optionally structural part is arranged such that the inner and outer structures may be dismantled from each other to allow the article of aid to be used.

Optionally the outer structure is selectively openable and closable such that when the outer structure is open, the, inner structure may be removed from the outer structure.

Optionally the outer structure comprises an opening and closing mechanism. The opening and closing mechanism may be lock tie, screw cap or non-return valve, for example.

Optionally the structural part is arranged such that is may be dismantled from the air vehicle in a configuration in which the inner and outer structures are attached to each other such that the article of aid may then be carried to a location by carrying the structural part to the location.

Optionally the disposable air vehicle comprises a plurality of said structural parts.

Optionally every structural part of the disposable air vehicle is a said structural part.

Optionally both the inner and outer structure comprise one or more of said articles of aid.

Optionally substantially the entire air vehicle consists of one or more articles of aid.

The disposable air vehicle may comprise a cooler arranged to keep the, or each, article of aid frozen during flight.

In an embodiment of the invention the outer structure is a different entity to the inner structure. In this respect, in an embodiment of the invention, the outer structure is not integrally formed with the inner structure. In an embodiment of the invention the outer structure is of a different material to the inner structure.

In an embodiment of the invention the, or each article of aid that forms the inner structure is a different entity to the, or each, article of aid that forms the outer structure.

In an embodiment of the invention the inner structure is not a solid block of material.

Optionally the disposable air vehicle is a heavier than air vehicle. Optionally the disposable air vehicle is a lighter than air vehicle.

The disposable air vehicle may be a fixed wing air vehicle, rotary wing air vehicle or a hybrid fixed and rotary wing air vehicle.

The disposable air vehicle may be an autonomous air vehicle.

The disposable air vehicle may be a remote controlled air vehicle.

The disposable air vehicle may comprise a propulsion system. The propulsion system may be an engine driven propeller, a turbo-fan engine or a jet engine, for example.

The disposable air vehicle may not have a propulsion system. In this regard, the disposable air vehicle may not have an engine to provide propulsion to the vehicle. The disposable air vehicle may be configured to be glide.

The disposable air vehicle may comprise a parachute. For example, the disposable air vehicle may be a paraglider. The parachute may comprise a canopy supported by a support structure. In this case, optionally the inner structure is the support structure and the outer structure is the canopy. The support structure may be one or more ribs. The outer structure may comprise said film of material. The parachute may be arranged to carry cargo suspended beneath the parachute.

The disposable air vehicle may comprise a retardation device suitable for slowing the descent of the air vehicle. The retardation device may be a parachute. The parachute may be a sniveller or drogue parachute. The parachute may have an automatic opening device.

According to a second aspect of the invention there is provided a structural part of an unmanned disposable air vehicle for use as part of a unmanned disposable air vehicle according to the first aspect of the invention, the structural part having an outer structure and an inner structure located inside the outer structure, the inner structure being arranged to support the outer structure, wherein at least one of the inner structure and outer structure comprises an article of aid such that an air vehicle comprising the structural part may be flown to a relief zone and the structural part dismantled from the air vehicle to allow the article of aid to be used.

According to a third aspect of the invention there is provided a method of delivering aid to a relief zone comprising flying an unmanned disposable air vehicle to the relief zone, the unmanned disposable air vehicle having a structural part comprising an article of aid, and dismantling the structural part from the air vehicle to allow the article of aid to be used in the relief zone.

Optionally the structural part is formed by the article of aid. Optionally the structural part consists of the article of aid.

Optionally the structural part comprises a plurality of articles of aid.

Optionally the structural part is formed by the articles of aid. Optionally the structural part consists of the articles of aid.

Optionally the method comprises subsequently carrying the article of aid to a location by carrying the structural part to the location.

Optionally the unmanned disposable air vehicle is an unmanned disposable air vehicle according to the first aspect of the invention.

Optionally the method comprises flying a plurality of said disposable air vehicles to the relief zone and, for each air vehicle, dismantling the structural part from the air vehicle to allow the article of aid to be used in the relief zone.

Optionally the method comprises launching the, or each, disposable air vehicle into flight.

The, or each, disposable air vehicle may be launched from an air vehicle. The air vehicle may be an airplane or helicopter, for example. The air vehicle may be a lighter than air vehicle, for example a balloon.

The, or each, disposable air vehicle may be launched from the rear of an air vehicle, into the airstream flowing behind the air vehicle.

The, or each, disposable air vehicle may be launched from the ground. The, or each, disposable air vehicle may be launched by a slingshot launcher. The, or each, disposable air vehicle may be launched by hand.

Optionally during the descent of the air vehicle, a retardation device is deployed from the air vehicle to slow the descent of the air vehicle.

The retardation device may be a parachute. The parachute may be a sniveller or drogue parachute, for example. The parachute may have an automatic opening device.

It will be appreciated that the method comprises landing the disposable air vehicle in the relief zone and dismantling the structural part from the air vehicle after the disposable air vehicle has landed, i.e. when the disposable air vehicle is on the ground.

According to a fourth aspect of the invention there is provided a method of assembly of an unmanned disposable air vehicle comprising assembling a structural part of an unmanned disposable air vehicle with a part of an unmanned disposable air vehicle to form an unmanned disposable air vehicle, wherein the structural part has an outer structure and an inner structure located inside the outer structure, the inner structure being arranged to support the outer structure, wherein at least one of the inner structure and outer structure comprises an article of aid such that the air vehicle may be flown to a relief zone and the structural part dismantled from the air vehicle to allow the article of aid to be used.

Optionally the unmanned disposable air vehicle is an unmanned disposable air vehicle according to the first aspect of the invention.

According to a fifth aspect of the invention there is provided a disposable air vehicle comprising a structural part that has an outer structure and an inner structure located inside the outer structure, the inner structure being arranged to support the outer structure, wherein at least one of the inner structure and outer structure comprises an article of aid such that the air vehicle may be flown to a relief zone and the structural part dismantled from the air vehicle to allow the article of aid to be used.

According to a sixth aspect of the invention there is provided a structural part of a disposable air vehicle for use as part of a disposable air vehicle according to the fifth aspect of the invention, the structural part having an outer structure and an inner structure located inside the outer structure, the inner structure being arranged to support the outer structure, wherein at least one of the inner structure and outer structure comprises an article of aid such that an air vehicle comprising the structural part may be flown to a relief zone and the structural part dismantled from the air vehicle to allow the article of aid to be used.

According to a seventh aspect of the invention there is provided a method of delivering aid to a relief zone comprising flying a disposable air vehicle to the relief zone, the disposable air vehicle having a structural part comprising an article of aid, and dismantling the structural part from the air vehicle to allow the article of aid to be used in the relief zone.

According to an eighth aspect of the invention there is provided a method of assembly of a disposable air vehicle comprising assembling a structural part of a disposable air vehicle with a part of a disposable air vehicle to form a disposable air vehicle, wherein the structural part has an outer structure and an inner structure located inside the outer structure, the inner structure being arranged to support the outer structure, wherein at least one of the inner structure and outer structure comprises an article of aid such that the air vehicle may be flown to a relief zone and the structural part dismantled from the air vehicle to allow the article of aid to be used.

Optionally the disposable air vehicle is a disposable air vehicle according to the fifth aspect of the invention.

The disposable air vehicle may be a manned air vehicle.

According to a ninth aspect of the invention there is provided a disposable air vehicle comprising a structural part that has an outer structure and an inner structure located inside the outer structure, the inner structure being arranged to support the outer structure, wherein the inner structure comprises an article of aid such that the air vehicle may be flown to a relief zone and the structural part dismantled from the air vehicle to allow the article of aid to be used.

According to a tenth aspect of the invention there is provided a disposable air vehicle comprising a structural part that has an outer structure and an inner structure located inside the outer structure, the inner structure being arranged to support the outer structure, wherein the outer structure comprises an article of aid such that the air vehicle may be flown to a relief zone and the structural part dismantled from the air vehicle to allow the article of aid to be used.

The features of any of the above aspects of the invention may be combined with one or more features of any of the other aspects of the invention, in any combination.

Other preferred and advantageous features of the invention will be apparent from the following description.

### DESCRIPTION OF THE DRAWINGS

Specific embodiments of the invention will now be described with reference to the description and schematic drawings.

FIG. 1 shows a plan view of an unmanned disposable air vehicle according to a first embodiment of the invention, where internal components of wings of the air vehicle have not been shown for illustrative purposes;

FIG. 2 shows a perspective view of a part of a wing, according to a second embodiment of the invention, of the unmanned disposable air vehicle shown in FIG. 1, towards the tip of the wing;

FIG. 3 shows a cross-sectional view of a stringer according to a third embodiment of the present invention, of the wing shown in FIG. 2, taken along a radial plane that is parallel to a longitudinal axis of the stringer;

FIG. 4 shows a cross-sectional view of the stringer shown in FIG. 3, taken along a radial plane that is perpendicular to the longitudinal axis of the stringer;

FIG. 5 shows a view corresponding to that of FIG. 3 but of a stringer according to a fourth embodiment of the invention;

FIG. 6 shows a view corresponding to that of FIG. 4 but of the stringer shown in FIG. 5;

FIG. 7 shows a cross-sectional view of a wing according to a fifth embodiment of the invention, of the air vehicle shown in FIG. 1, taken along a radial plane that is perpendicular to the longitudinal axis of the wing;

FIG. 8 shows a plan view of the wing shown in FIG. 7;

FIG. 9 shows a cross-sectional view of a rib according to a sixth embodiment of the invention, of the wing shown in FIG. 2, taken along a radial plane that is perpendicular to the longitudinal axis of the rib;

FIG. 10 shows a perspective view of part of a lower half of a fuselage, according to a seventh embodiment of the invention, of the unmanned disposable air vehicle shown in FIG. 1;

FIG. 11 shows a schematic front view of an undercarriage, according to an eighth embodiment of the invention, of the air vehicle shown in FIG. 1;

FIG. 12 shows a plan view of a housing, according to a ninth embodiment of the invention, for a navigation system of the air vehicle shown in FIG. 1;

FIG. 13 shows a plan view of a cargo container according to a tenth embodiment of the invention, of the air vehicle shown in FIG. 1, and

FIG. 14 shows a schematic front view of an undercarriage, according to an eleventh embodiment of the invention, of the air vehicle shown in FIG. 1.

### DETAILED DESCRIPTION

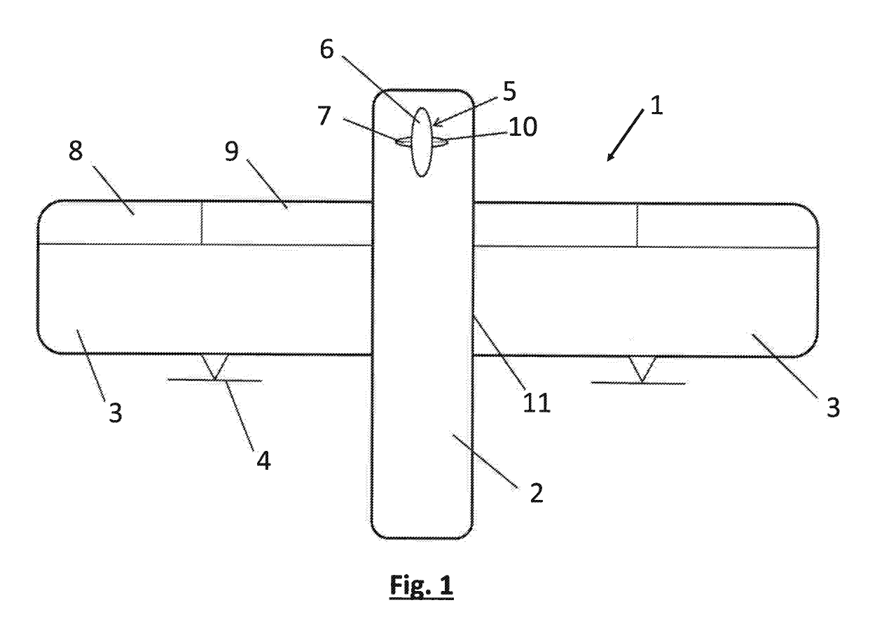

Referring to FIG. 1 there is shown a plan view of an unmanned disposable air vehicle 1 according to a first embodiment of the invention (where internal components of each wing 3 have not been shown for illustrative purposes). The unmanned disposable air vehicle 1 is a fixed wing airplane.

The unmanned disposable air vehicle 1 comprises an airframe and a propulsion system.

The airframe comprises a fuselage 2, first and second wings 3 disposed on opposite sides of the fuselage 2 and a tail 5.

The propulsion system comprises first and second propeller engines 4, with each engine 4 being mounted under a respective wing 3, at the leading edge of the wing 3.

The tail 5 comprises a vertical stabiliser 6 and a horizontal stabiliser 7. The vertical stabiliser 6 is provided with a rudder (not shown) for controlling the yaw of the air vehicle 1. The horizontal stabiliser 7 is provided with an elevator 10 for controlling the pitch of the air vehicle 1.

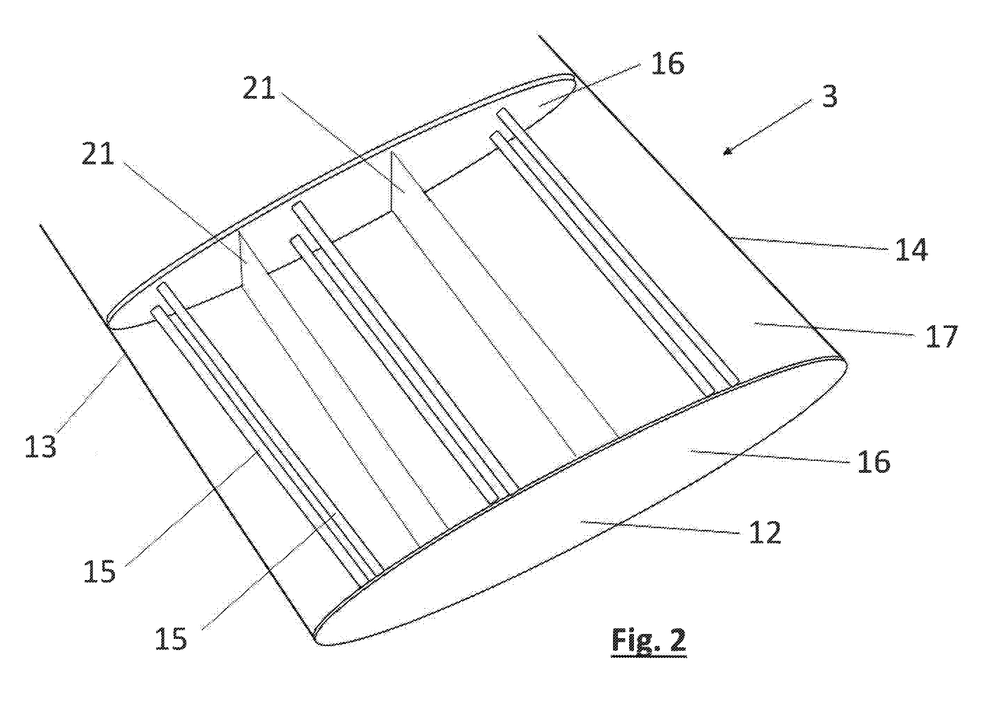

Each wing 3 extends along a longitudinal axis from a root 11 (see FIG. 1) to a tip 12 (see FIG. 2) and along a lateral axis from a leading edge 13 to a trailing edge 14.

Each wing 3 comprises an aileron 8, towards the tip 12 of the wing 3 and a flap 9 towards the root 11 of the wing 3 (see FIG. 1).

The ailerons 8, rudder and elevator 10 form the control surfaces of the air vehicle 1 and are controlled using a conventional fly by wire control system. The air vehicle is controlled by remote control. It will be appreciated that the air vehicle has suitable telemetry (e.g. signal receivers, transmitters controllers and actuators to control the control surfaces) and control systems such that the air vehicle is controllable remotely, i.e. by an operator on the ground using a suitable remote controller.

Alternatively, the air vehicle 1 may be an autonomous air vehicle 1. It will be appreciated that, in this case, the air vehicle 1 will have suitable telemetry (e.g. signal receivers, transmitters, controllers and actuators to control the control surfaces) and control systems such that the air vehicle can fly autonomously, i.e. on auto-pilot. This includes flying autonomously in every phase of flight, including take-off, cruise and landing.

Each wing 3 forms a load-bearing structural part of the air vehicle 1. Each wing 3 is load-bearing in that, during flight, aerodynamic forces are exerted on the wing (resulting in shear forces and bending moments exerted on the wing 3). Each wing 3 is also load-bearing in that when the air-vehicle is stationary, the weight of the wing 3 exerts shear forces and bending moments on the wing 3.

Each wing 3 is substantially identical and so, for conciseness, only one of the wings 3 will be described. It will be appreciated that the other wing 3 has corresponding identical features. Corresponding features are given corresponding reference numerals.

Referring to FIG. 2 there is shown a perspective view of a section of the port wing 3 of the air vehicle 1 towards the tip 12 of the wing 3. The wing 3 is a wing 3 according to a second embodiment of the invention.

The wing 3 has a cross-sectional shape (in a plane perpendicular to the longitudinal axis of the wing) of an aerofoil.

The wing 3 comprises an outer wing skin 17 that defines the outer shape of the wing 3. In this regard, an outer surface of the wing skin 17 forms the outer surface of the wing 3 that contacts the oncoming air during flight and provides a lifting surface.

The wing 3 comprises a plurality of ribs 16 distributed in the longitudinal direction of the wing 3. Each rib 16 has the shape of a plate that is substantially perpendicular to the longitudinal axis of the wing 3 and has an outer shape (when looking face on at the plate) that corresponds to that of an inner surface of the wing skin 17 at that longitudinal position along the wing. Each rib 16 extends from the leading edge 13 to the trailing edge 14 of the wing 3.

An outer surface of each rib 16 is attached to the inner surface of the wing skin 17 by rivets. It will be appreciates that any suitable means of attachment may be used. The ribs 16 support the wing skin 17 and provide rigidity to the wing 3. In this regard, the ribs 16 increase the rigidity of the wing skin 17. Each rib 16 has a rigidity that is greater than that of the wing skin 17. The ribs 16 act to increase the torsional rigidity of the wing skin 17, for example in a plane of twisting that is perpendicular to the longitudinal axis of the wing 3, and to increase the resistance of the wing 3 to bending. Each rib 16 transmits a load applied to the wing 3 (e.g. due to aerodynamic forces on the wing) through the wing 3.

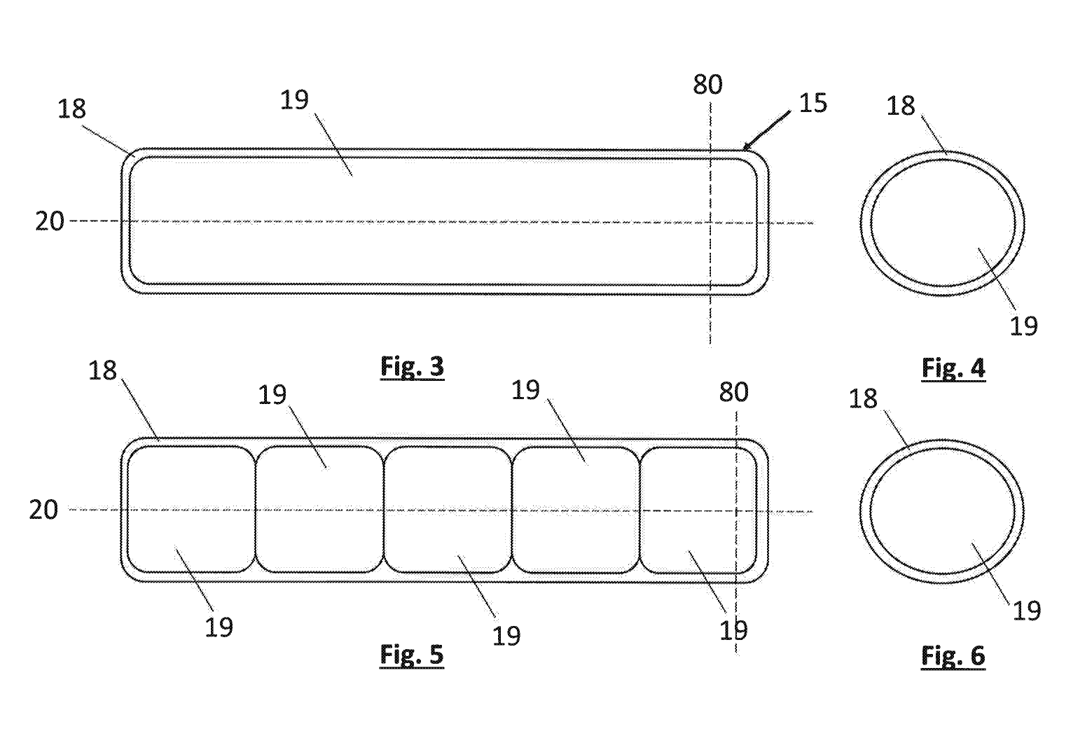

The wing 3 further comprises a plurality of stringers 15, disposed within the wing 3, that extend along the length of the wing. Each stringer 15 has the shape of a cylinder that extends along a longitudinal axis 20 (see FIGS. 3 and 5) that is substantially parallel to the longitudinal axis of the wing 3. Each stringer 15 passes through the ribs 16, through respective circular apertures in the ribs 16.

Each stringer 15 supports the wing skin 17 and provides rigidity to the wing 3. Each stringer 15 increases the rigidity of the wing skin 17. In this regard, each stringer 15 has a rigidity that is greater than that of the wing skin 17. The stringers 15 act to increase the torsional rigidity of the wing skin 17, for example in a plane of twisting that is perpendicular to the longitudinal axis of the wing 3, and to increase the resistance the wing 3 to bending. Each stringer 15 transmits a load applied to the wing 3 (e.g. due to aerodynamic forces on the wing) through the wing 3.

In the currently described embodiment the stingers 15 are arranged into three pairs distributed in the direction of the lateral axis of the wing 3. The stringers 15 in each pair are located at corresponding positions in the direction of the lateral axis of the wing 3 and are vertically spaced from each other.

The wing 3 further comprises a plurality of spars 21, disposed within the wing 3, that extend in the longitudinal direction of the wing. Each spar 21 has the shape of a plate that is substantially perpendicular to the lateral axis of the wing 3. Each spar 21 passes through suitably shaped slots in the ribs 16.

Each spar 21 supports the wing skin 17 and provides rigidity to the wing 3. Each spar 21 increases the rigidity of the wing skin 17. In this regard, each spar 21 has a rigidity that is greater than that of the wing skin 17. The spars 21 act to increase the torsional rigidity of the wing skin 17 and to increase the resistance of the wing 3 to bending. Each spar 21 transmits a load applied to the wing 3 (e.g. due to aerodynamic forces on the wing) through the wing 3.

The stringers 15, ribs 16 and spars 21 are support structures for the wing 3.

Wings comprising wing stringers, ribs and spars are well known in the art and so their general arrangement and function will not be described in any further detail.

Referring again to FIG. 2, each wing 3 is a structural part of the air vehicle 1. For each wing 3, the wing skin 17 is made of an article of aid, for use in a relief zone, i.e. a zone that requires aid relief. This might be an area of the world affected by a natural disaster, war or famine, for example.

In the currently described embodiment, the wing skin 17 is made of an article of aid in the form of a thin film of edible gelatine. Alternatively, or additionally, the article of aid may be a film of any material for use as aid, such as an edible material (e.g. a film of a seaweed derivative) or a film formed from a drug.

Alternatively, or additionally, the wing skin 17 may be made of a biodegradable material and/or a disposable material. In the currently described embodiment the wing skin 17 is thermoformed. It may be formed by any suitable process, including 3D printing, for example.

Referring to FIGS. 3 and 4 there is shown a stringer 15 of the wing 3 shown in FIG. 2. The stringer 15 is a stringer according to a third embodiment of the present invention.

Each stringer 15 is a load-bearing structural part of the air vehicle 1.

Each stringer 15 comprises an article of aid 19 contained within a cover in the form of a sleeve 18.

In the embodiment shown in FIGS. 3 and 4, the article of aid 19 is a solid block 19 of a compressed edible foodstuff (i.e. a foodstuff edible by a human to provide the human with sustenance). Alternatively, the solid block 19 may be a solid block of any other type of aid, for example a solid block of fuel or a solid block of a medical drug.

The sleeve 18 is made of polyethylene. The sleeve 18 is arranged to contain the block 19 of compressed foodstuff within the sleeve 18. In this regard, the sleeve forms a substantially closed enclosure around the block 19. Alternatively, or additionally, the sleeve 18 may be made of an article of aid (e.g. an edible film of material), a biodegradable material and/or a disposable material.

The block 19 forms an inner structure of the stringer 15 and the sleeve 18 forms an outer structure of the stringer 15. The block 19 is of greater rigidity than the sleeve 18 and supports the sleeve 18.

The block 19 is vacuum packed in the sleeve 18. This may advantageously protect the block 19 of foodstuff and acts to contain the block 19.

The sleeve 18 is sealed around the block 19 by a lock tie (see below). Alternatively, the sleeve 18 may be heat sealed closed. The sleeve 18 may be 3D printed.

Each stringer 15 forms an inner structure of the wing 3, with the wing skin 17 forming an outer structure of the wing 3. Each stringer 15 is located inside the wing 3.

For each stringer 15, the rigidity of the block 19 is such that the stringer 15 is of greater rigidity than the wing skin 17 and supports the wing skin 17.

For each stringer 15, the block 19 is arranged to transmit an applied load substantially along the length of the stringer 15.

The applied load is due to aerodynamic forces on the wing 3 when the air vehicle 1 is in flight. The applied load is also due to forces exerted on the wing 3 when the air vehicle 1 is on the ground, including when stationary or when taxiing. The applied load is a shearing force, bending moment and/or twisting moment.

For each stringer 15, the rigidity of the block 19 is such that the stringers 15 act to increase the torsional rigidity of the wing skin 17 and to increase the resistance of the wing 3 to bending.

Referring to FIGS. 5 and 6 there is shown a stringer 15 according to a fourth embodiment of the present invention. The stringer 15 of the fourth embodiment is identical to the stringer 15 of the third embodiment (shown in FIGS. 3 and 4) except for the differences described below. Corresponding features are given corresponding reference numerals.

In the embodiment shown in FIGS. 5 and 6, each stringer 15 comprises a plurality of articles of aid 19 contained within a cover in the form of a sleeve 18.

The articles of aid 19 are solid blocks 19 of compressed edible foodstuffs. The blocks 19 may be the same or different foodstuffs.

Alternatively, the solid blocks 19 may be solid blocks of any other type of aid, for example solid blocks of fuel or solid blocks of medical drugs.

The blocks 19 are arranged to form a chain (i.e. a one dimensional array of blocks). In this regard, adjacent blocks 19 in the chain are in contact with each other and are pushed against each other due to a compressive force exerted by the sleeve 18. This provides rigidity to the stringer 15.

In the described embodiment the blocks 19 are not attached to each other. Alternatively, one or more adjacent blocks 19 may be attached to each other, to increase the rigidity of the stringer 15.

Alternatively, or additionally, one or more adjacent blocks 19 may be separated by an intermediary member arranged to transmit the load between adjacent blocks 19.

In the currently described embodiment the chain of blocks 19 is straight, i.e. the longitudinal axis of the chain is straight. Alternatively, the chain of blocks may be curved, or part-curved along its length, for example if the stringer 15 is curved.

As with the embodiment of the stringer 15 shown in FIGS. 3 and 4, the sleeve 18 is made of polyethylene. The sleeve 18 is arranged to contain the blocks 19 of a compressed foodstuff within the sleeve 18. In this regard, the sleeve forms a substantially closed enclosure around the blocks 19.

The blocks 19 together form an inner structure of the stringer 15 and the sleeve 18 forms an outer structure of the stringer 15. The blocks 19 together form a structure that is of greater rigidity than the sleeve 18 and supports the sleeve 18.

The blocks 19 are vacuum packed in the sleeve 18. The sleeve 18 is sealed around the blocks 19.

For each stringer 15, the blocks 19 together form a structure that has a rigidity that is greater than that of the wing skin 17 and that supports the wing skin 17.

The rigidity of the array of blocks 19 is such that the stringers 15 act to increase the torsional rigidity of the wing skin 17 and to increase the resistance of the wing 3 to bending.

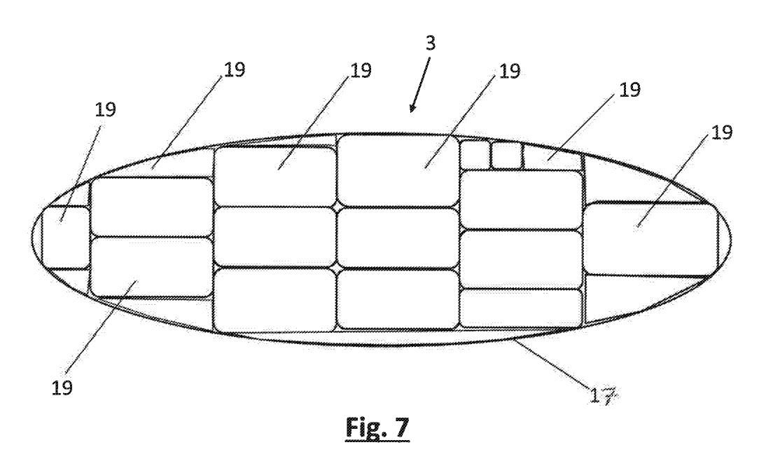

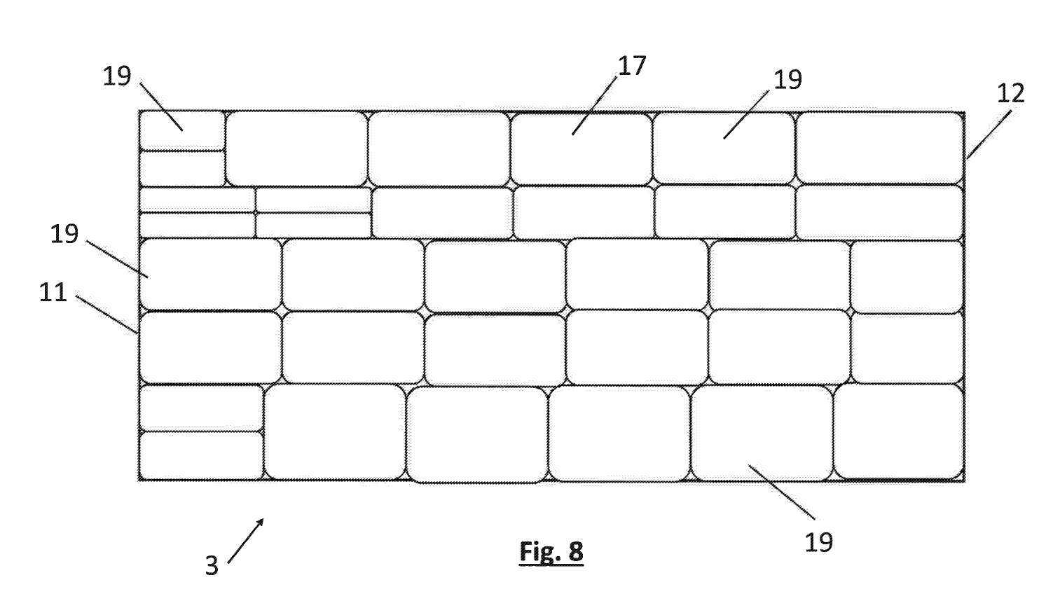

Referring to FIGS. 7 and 8 there is shown a wing 3 according to a fifth embodiment of the invention taken along a radial plane that is perpendicular to the longitudinal axis of the wing 3. The wing 3 shown in FIGS. 7 and 8 may be used as each wing of the air vehicle shown in FIG. 1.

The wing 3 shown in FIG. 7 is identical to the wing 3 shown in FIG. 2, except for the differences described below. Corresponding features are given corresponding reference numerals.

In the embodiment shown in FIG. 7, a plurality of articles of aid 19 are provided inside of the wing skin 17. In this regard, the wing skin 17 forms a substantially closed enclosure around the blocks 19.

The blocks 19 are arranged to form a three dimensional array. In this regard, the array of blocks 19 extends in the longitudinal and lateral directions of the wing 3, as well as in a thickness direction of the wing 3 (the direction perpendicular to the longitudinal and lateral directions of the wing). The blocks 19 substantially fill the volume that is enclosed by the wing skin 17.

Adjacent blocks 19 in the array are in contact with each other and are pushed against each other due to a compressive force exerted by the wing skin 17. This provides rigidity to the wing skin 17 and therefore to the wing 3.

In the currently described embodiment the blocks 19 are not attached to each other. Alternatively, one or more adjacent blocks 19 may be attached to each other, to increase the rigidity of the wing 3.

Alternatively, or additionally, one or more adjacent blocks 19 may be separated by an intermediary member arranged to transmit the load between adjacent blocks.

The array of blocks 19 together form an inner structure of the wing 3 and the wing skin 17 forms an outer structure of the wing 3. The blocks 19 together form a structure that is of greater rigidity than the wing skin 17 and supports the wing skin 17.

The array of blocks 19 are arranged to transmit a load applied to the wing 3 along the length, width and thickness of the wing.

In this regard, the blocks 19 together form a structure that acts to increase the torsional rigidity of the wing skin 17 and to increase the resistance of the wing 3 to bending.

As with the previous embodiment, the articles of aid 19 are solid blocks 19 of compressed edible foodstuffs. The blocks 19 may be the same or different foodstuffs.

Alternatively, the solid blocks 19 may be solid blocks of any other type of aid, for example solid blocks of fuel or solid blocks of medical drugs.

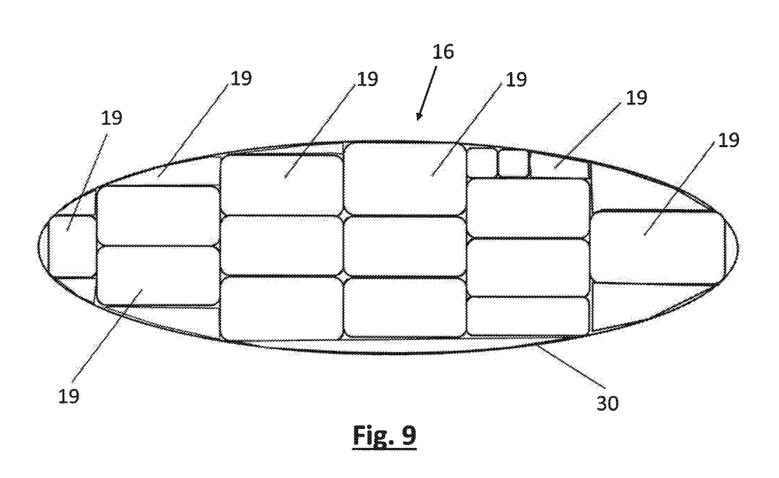

Referring to FIG. 9 there is shown a wing rib 16 according to a sixth embodiment of the invention, of the wing 3 shown in FIG. 2, taken along a radial plane that is perpendicular to the longitudinal axis of the wing 3.

The rib 16 corresponds to each rib 16 of the wing 3 shown in FIG. 2. Corresponding features are given corresponding reference numerals.

Each rib 16 is a load-bearing structural part of the air vehicle 1.

In the embodiment shown in FIG. 9, the rib 16 comprises a flexible outer skin 30, of a film of edible gelatine, and a plurality of articles of aid 19 provided inside of the outer skin 30. In this regard, the outer skin 30 forms a substantially closed enclosure around the blocks 19.

The blocks 19 are arranged to form a two dimensional array (there is only one set of blocks in the lateral direction). In this regard, the array of blocks 19 extends in the longitudinal and thickness directions of the rib 16. The blocks 19 substantially fill the volume that is enclosed by the outer skin 30.

Adjacent blocks 19 in the array are in contact with each other and are pushed against each other due to a compressive force exerted by the outer skin 30. This provides rigidity to the outer skin 30 and therefore to the rib 16.

The blocks 19 are not attached to each other. Alternatively, one or more adjacent blocks 19 may be attached to each other, to increase the rigidity of the rib 16.

Alternatively, or additionally, one or more adjacent blocks 19 may be separated by an intermediary member arranged to transmit the load between adjacent blocks 19.

The blocks 19 together form an inner structure of the rib 16 and the outer skin 30 forms an outer structure of the rib 16. The blocks 19 together form a structure that is of greater rigidity than the outer skin 30 and supports the outer skin 30.

In this regard, the blocks 19 together form a structure that acts to increase the torsional rigidity of the outer skin 30 and to increase the resistance of the rib 16 to bending.

The array of blocks 19 are arranged to transmit a load applied to the rib 16 along the length, width and thickness of the rib 16.

As with the previous embodiment, the articles of aid 19 are solid blocks 19 of compressed edible foodstuffs. The blocks 19 may be the same or different foodstuffs.

Alternatively, the solid blocks 19 may be solid blocks of any other type of aid, for example solid blocks of fuel or solid blocks of medical drugs.

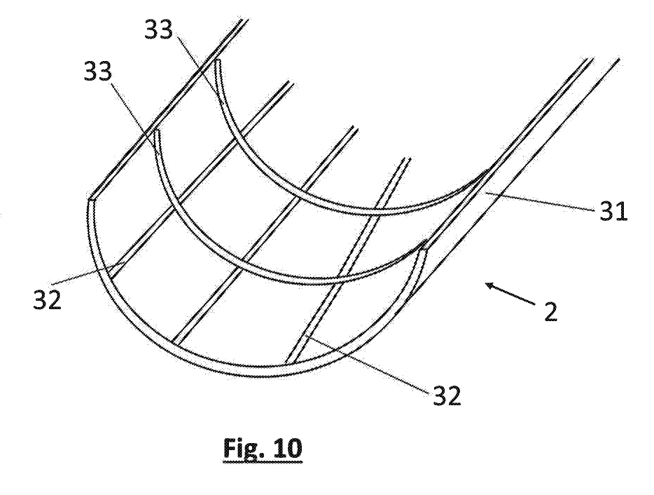

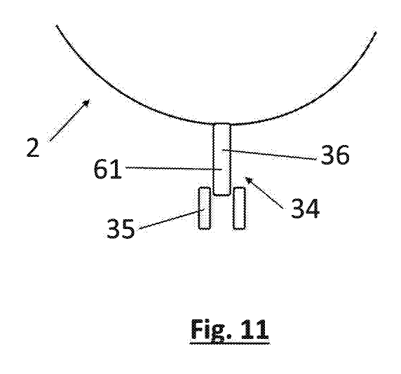

Referring to FIG. 10 there is shown a perspective view of part of a lower half of the fuselage 2, according to a seventh embodiment of the invention, of the unmanned disposable air vehicle shown in FIG. 1.

The fuselage 2 has the general shape of a hollow cylinder. The fuselage 2 comprises an outer skin 31 that defines the outer shape of the fuselage 2. In this regard, an outer surface of the fuselage skin 31 forms the outer surface of the fuselage 2 that contacts the oncoming air during flight.

The fuselage 2 comprises a plurality of circular frames 33 distributed in the longitudinal direction of the fuselage 2. Each frame 33 has the shape of a circular hoop that has an outer shape that corresponds to that of the fuselage skin 31 at that longitudinal position of the wing. A radially outer surface of each frame 33 is attached to the inner surface of the fuselage skin 31 by rivets. The frames 33 form a load bearing support structure of the fuselage 2 that supports the fuselage and provides rigidity to the fuselage 2.

In this regard, the frames 33 support the fuselage skin 31 and provide rigidity to the skin 31. Each frame 33 has a rigidity that is greater than that of the fuselage skin 31. The frames 33 act to increase the torsional rigidity of the fuselage skin 31.

The fuselage 2 further comprises a plurality of stringers 32, disposed within the fuselage skin 31 (i.e. within the enclosure defined by the fuselage skin 31), that extend along the length of the fuselage 2. The stringers 32 are distributed in a circumferential direction about an inner surface of the fuselage skin 31.

Each stringer 32 is attached to an inner surface of the fuselage skin 31 and passes through respective slots in the frames 33. The stringers 32 support the fuselage skin 31 and provide rigidity to the fuselage. Each stringer 32 increases the rigidity of the fuselage skin 31. In this regard, each stringer 32 has a rigidity that is greater than that of the fuselage skin 31. The stringers 32 act to increase the torsional rigidity of the fuselage skin 31 and to increase the resistance of the fuselage skin 31 to bending.

In the described embodiment, a lower half of the fuselage skin 31 is made from PVC coated cardboard and an upper half of the fuselage skin 31 is made from industrial cling film. Alternatively, or additionally, the fuselage skin may be made from an article of aid (e.g. a film of an edible foodstuff) and/or a biodegradable material and/or a disposable material.

Each stringer 32 has a structure that corresponds to that of the stringer 15 shown in FIGS. 5 and 6. In this regard, each stringer 32 comprises a plurality of said articles of aid 19 contained within a cover in the form of a said sleeve 18.

It will be appreciated that alternatively, or additionally, each stringer 32 may have a structure that corresponds to the stringer 15 shown in FIGS. 3 and 4.

Alternatively, or additionally, a bulkhead of the fuselage (not shown) may comprise one or more articles of aid 19, having the general structure of the rib 16 shown in FIG. 9, i.e. one or more articles of aid 19 contained within a flexible skin.

Referring to FIG. 11 there is shown a schematic view of an undercarriage 34, according to an eighth embodiment of the invention, of the air vehicle shown in FIG. 1.

The undercarriage 34 comprises a pair of wheels 35 rotatably mounted on a strut 36. The strut 36 has an outer skin 61 supported by an inner support frame (not shown). The skin 61 is made of an edible film of gelatine.

Alternatively, or additionally, the inner frame may be made of one or more of said articles of aid 19.

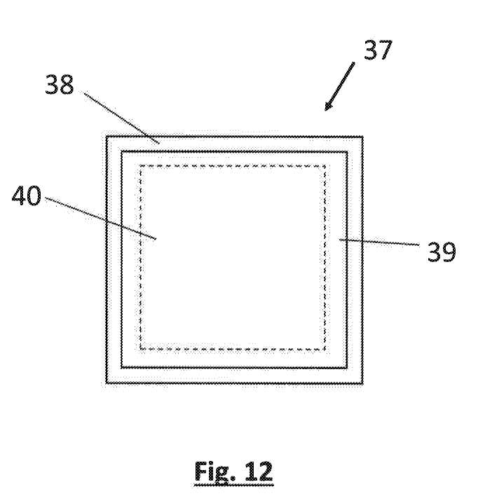

Referring to FIG. 12 there is shown a plan view of a housing 37 according to a ninth embodiment of the invention, for a power system 40, in the form of an array of battery packs (shown schematically as a dotted square) of the air vehicle shown in FIG. 1.

The housing 37 comprises an inner structure in the form of a rigid housing body 38 made of biodegradable balsa wood. It will be appreciated that any suitable biodegradable material may be used. Alternatively or additionally, the inner structure may be formed by an article of aid, such one or more blocks of a foodstuff.

The housing body 38 has the shape of a substantially hollow cube that defines an internal chamber of receiving the power system 40.

The housing 37 is provided with a skin 39 that substantially encloses the housing 37 and is heat sealed closed. The skin 61 is made of an edible film of gelatine.

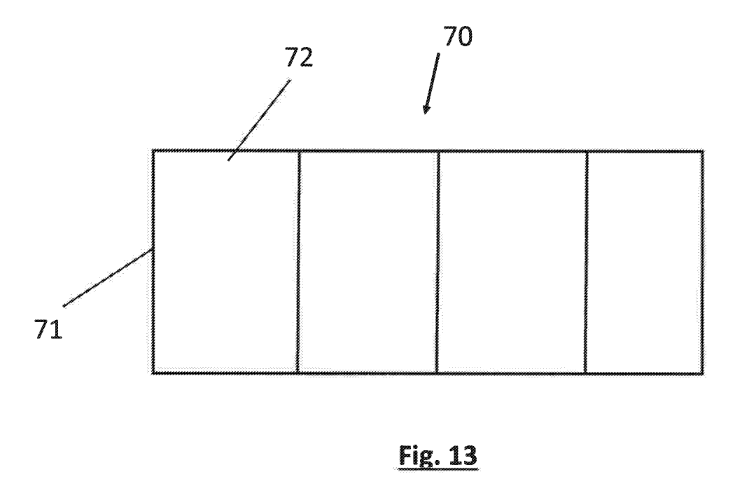

Referring to FIG. 13 there is shown a plan view of a cargo container 70 according to a tenth embodiment of the invention, of the air vehicle shown in FIG. 1. The cargo container 70 is located in the fuselage 2.

The cargo container 70 comprises a frame formed by a plurality of frame members 71 that together define cargo compartments 72 for receiving cargo. Each cargo compartment 72 has the general shape of a cube.

Each frame member 71 has a general structure that corresponds to that of the stringer 15 shown in FIGS. 5 and 6. In this regard, each frame member 71 comprises a plurality of said articles of aid 19 contained within a cover in the form of a said sleeve 18.

It will be appreciated that alternatively, or additionally, each frame member 71 may have a structure that corresponds to the stringer 15 shown in FIGS. 3 and 4.

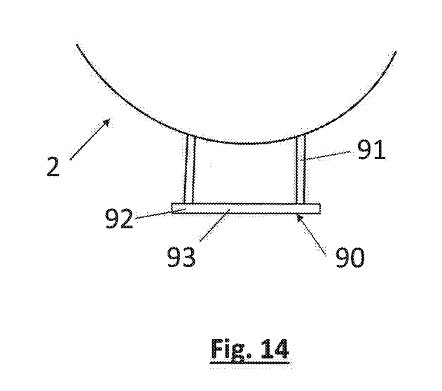

FIG. 14 shows a schematic view of an undercarriage 90, according to an eleventh embodiment of the invention. The undercarriage 90 may be used, on the air vehicle 1, in place of the undercarriage 34 shown in FIG. 11.

The undercarriage 90 comprises a sled 92 attached to the underside of the fuselage 2 by a pair of laterally spaced vertical struts 91.

The sled 92 has an outer skin 93 supported by an inner support frame (not shown). The skin 93 is made of an edible film of gelatine.

The inner support frame is made from a biodegradable balsa wood. Alternatively, or additionally, the inner frame may be made of an article of aid.

Alternatively, or additionally, one or both of the struts 91 may comprise an article of aid.

In each of the described embodiments, the respective structural parts of the air vehicle 1 (i.e. the wing 3, stringers 15, spars 21, ribs 16, fuselage 2, fuselage stringers 32, fuselage frames 33, fuselage bulkheads, undercarriage 34, 90, cargo compartments 70 and power housing 37) are arranged such that they may be dismantled from the air vehicle 1, i.e. from the remainder of the air vehicle, to allow the, or each, article of aid 19 to be used.

Furthermore, the respective structural parts are arranged such that the, or each, article of aid 19 may be removed from the structural part, i.e. from the remainder of the structural part, to allow the article of aid to be used.

For example, the wing 3, fuselage 2 and undercarriage 34 are arranged such that they may be dismantled from each other.

In addition, each stringer 15, spar 21, rib 16 is arranged so that is may be dismantled from the wing. In this respect each stringer 15 is mounted in apertures in the respective ribs 16 such that it is slidably removable from the ribs 16.

Furthermore, in the embodiments shown in FIGS. 3 to 5, for each stringer 15, the sleeve 18 is selectively openable and closable such that when the sleeve 18 is open, the, or each article of aid 19 may be removed from the sleeve 18.

In this regard, the sleeve 18 is closed along line 80 (see FIGS. 3 and 5) by a lock tie that may be fastened and unfastened to opened and close the sleeve 18.

Alternatively, or additionally, the opening and closing mechanism may be a screw cap or non-return valve, for example.

The air vehicle 1 is used to deliver aid, to a relief zone, by a method according to a further embodiment of the invention.

The method comprises flying the air vehicle 1 to a relief zone, i.e. an area of the world where aid relief is required (such as a disaster zone, war zone, area of famine, etc.), landing the air vehicle 1 in the relief zone and dismantling one or more of the structural parts to allow the articles of aid 19 to be used.

For example, the wings 3 and fuselage 2 are dismantled from the wing, the stringers 15, ribs 16, spars 21 and wing skin 17 are dismantled from each other, the stringers 32, frames 33 and fuselage skin 31 are dismantled from each other, etc., to allow the respective articles of aid 19 to be used.

Furthermore, each stringer is slidably removed from the wing 3. This is done while the sleeve 18 is closed (by said lock tie). This allows the stringer 15 to be used as a carrying device to carry the aid 19 to a desired location, where the sleeve 18 is then opened to allow the aid 19 to be used.

The air vehicle 1 is disposable in that once one or more of said structural parts have been dismantled from the air vehicle 1, the air vehicle 1 can no longer be re-used to fly again.

The air vehicle 1 may have different sizes corresponding to the amount of aid that needs to be delivered. The air vehicle 1 may be for providing four, six or eight man days of rations, for example.

In the described embodiment the air vehicle 1 is launched from the rear of a cargo airplane, into the airstream flowing behind the airplane. The air vehicle 1 is then flown (remotely) to the relief zone and landed there.

The disposable air vehicle 1 comprises a retardation device (not shown) in the form of a parachute that is deployed during the descent of the air vehicle to slow the descent of the air vehicle on landing. The parachute may have an automatic opening device. This advantageously prevents damage to the articles of aid 19 when the vehicle 1 impacts the ground. The parachute may be a sniveller or drogue parachute, for example.

In a further embodiment, the method comprises flying a plurality of said disposable air vehicles 1 to the relief zone (as described above) and, for each air vehicle 1, dismantling the structural part from the air vehicle to allow the article of aid to be used in the relief zone. The plurality of air vehicles 1 may form a swarm.

It will be appreciated that different methods of launching may be used. For example, the aircraft from which the disposable air vehicle 1 is launched may be a helicopter or a balloon. Alternatively, the disposable air vehicle 1 may be launched from the ground, for example by a slingshot launcher or by hand.

The method of delivering aid may be used with any disposable air vehicle that has a structural part that comprises an article of aid and that may be dismantled from the air vehicle to allow the article of aid to be used in the relief zone. In this regard, the method of delivering aid is not limited to the disposable air vehicle 1 of the described embodiments.

According to a further embodiment of the invention, there is provided a method of assembly of the unmanned disposable air vehicle 1 comprising assembling the wing 3 with the fuselage 3 to form the unmanned disposable air vehicle 1.

In the described embodiments, every structural part of the air vehicle comprises one or more of said articles of aid 19.

In the described embodiments of the invention the article of aid 19, or the array formed by the articles of aid 19, is sufficiently rigid such that the respective structural part is able to withstand the forces exerted on it throughout the operational envelope of the air vehicle 1.

In each of the described embodiments, in respect of each structural part that comprises one or more articles of aid 19, the respective outer structure (e.g. the wing skin 17 or fuselage skin 31) is a different entity to the respective inner structure (e.g. the support structure of the wing skin or fuselage skin). In this respect, the respective outer structure is not integrally formed with the respective inner structure.

The above described embodiments are advantageous in that they allow the disposable air vehicle 1 to be used to deliver a relatively large amount of aid to a relief zone, than might otherwise be possible. In this respect, the amount of aid that the air vehicle 1 can deliver is not limited by an internal cargo space, for example in a fuselage of the air vehicle, since one or more structural components of the air vehicle may comprise an article of aid.

This may provide a relatively efficient way of delivering aid since one or more components of the air vehicle 1 may be used to provide aid.

The use of an unmanned air vehicle to deliver aid may be advantageous in that unmanned air vehicles can land in smaller landing sites and with less preparation of the landing site, if any. This may allow aid to be delivered closer to a target location in a relief zone, than would otherwise be possible.

The cost of using the unmanned disposable air vehicle 1 may be relatively low, compared to conventional cargo aircraft.

It will be appreciated that numerous modifications to the above described design may be made without departing from the scope of the invention as defined in the appended claims.

For example, in the described embodiments, each article of aid 19 is a compressed foodstuff.

Alternatively, or additionally, the, or each, article of aid 19 may comprise, or consist of solid fuel, medical equipment or drugs, for example.

Alternatively, or additionally, the, or each, article of aid may be drinkable. Alternatively, or additionally, the, or each, article of aid, and/or one or more other structural components of the air vehicle 1 may be biodegradable. In this respect, the, or each article of aid, and/or one or more other structural components of the air vehicle may be made from balsa wood, bamboo, soft wood or MDF, for example. Alternatively, or additionally, the, or each, article of aid, and/or one or more other structural components of the air vehicle 1 may be disposable.

Alternatively, or additionally, each article of aid may be a frozen liquid. The frozen liquid may provide rigidity to the respective structural part. For example, the, or each, article of aid may be water frozen as ice. The disposable air vehicle may comprise a cooler arranged to keep the, or each, article of aid frozen during flight.

In one or more of the described embodiments, both the inner and outer structures of the respective structural part comprise an article of aid. Alternatively, in those embodiments, only one of the inner or outer structures may comprise the, or each, article of aid.

In one or more of the described embodiments, only the inner or outer structures of the respective structural part comprise an article of aid. Alternatively, in those embodiments, both the inner or outer structures may comprise one or more of said articles of aid 19.

Alternatively, or additionally, the structural part that comprises the article(s) of aid 19 may be a control surface of the air vehicle, a wing of the tail, for example a horizontal or vertical stabiliser, an aileron, an elevator, a rudder and/or a flap.

Alternatively, or additionally, the structural part that comprises the article(s) of aid 19 may be a winglet. The winglet may be provided at a tip of a wing of the air vehicle. The winglet may be inclined to the horizontal such that it forms a dihedral winglet.

Alternatively, or additionally, the structural part that comprises the article(s) of aid may be a rotary wing or any other structure of a propulsion system of an air vehicle.

In the described embodiments the air vehicle 1 is a fixed wing airplane.

Alternatively, the disposable air vehicle may be a rotary wing air vehicle or a hybrid fixed and rotary wing air vehicle.

The disposable air vehicle may be a lighter than air vehicle.

The disposable air vehicle may be an autonomous air vehicle.

The disposable air vehicle may comprise a parachute. For example, the disposable air vehicle may be a paraglider. The parachute may be arranged to carry cargo suspended beneath the parachute. The parachute may comprise a canopy supported by a support structure. The support structure may comprise one or more articles of aid (for example it may have a structure corresponding to that of the stringers 15 in FIG. 3 or 5). The canopy may me made of a film of edible material.

The propulsion system may alternatively, or additionally, be a turbo-fan engine or a jet engine, for example.

The disposable air vehicle may be a manned air vehicle.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. An unmanned disposable air vehicle comprising a structural part that has an outer structure and an inner structure located inside the outer structure, the inner structure being arranged to support the outer structure, wherein at least one of the inner structure and outer structure comprises an article of aid such that the air vehicle may be flown to a relief zone and the structural part dismantled from the air vehicle to allow the article of aid to be used.

2. An unmanned disposable air vehicle according to claim 1 wherein the at least one of the inner structure and outer structure comprises a single article of aid.

3. An unmanned disposable air vehicle according to claim 2 wherein the article of aid is arranged such that a load applied to the structural part is transmitted through the structural part.

4. An unmanned disposable air vehicle according to claim 1 wherein the at least one of the inner structure and outer structure comprises a plurality of articles of aid.

5. An unmanned disposable air vehicle according to claim 4 wherein the articles of aid are arranged such that a load applied to the structural part is transmitted through the structural part.

6. (canceled)

7. An unmanned disposable air vehicle according to claim 1 wherein the inner structure comprises the, or each, article of aid.

8. An unmanned disposable air vehicle according to claim 1 wherein the outer structure comprises the, or each, article of aid.

9. An unmanned disposable air vehicle according to claim 1 wherein the structural part is a wing.

10. An unmanned disposable air vehicle according to claim 9 wherein the inner structure is a support structure of the wing.

11. An unmanned disposable air vehicle according to claim 9 wherein the outer structure is a skin of the wing.

12. An unmanned disposable air vehicle according to claim 1 wherein the structural part is a fuselage.

13. An unmanned disposable air vehicle according to claim 12 wherein the outer structure is a skin of the fuselage.

14. (canceled)

15. An unmanned disposable air vehicle according to claim 1 wherein the structural part is at least one of a support structure of a wing or a support structure of a fuselage.

16. (canceled)

17. An unmanned disposable air vehicle according to claim 1 wherein at least one of:
the structural part forms one or more cargo compartments of the air vehicle:,
the structural part is an undercarriage of the air vehicle;
the structural part is a housing for a system of the air vehicle.

18. (canceled)

19. (Canceled)

20. An unmanned disposable air vehicle according to claim 7, wherein the, or each, article is vacuum packed in the outer structure.

21. An unmanned disposable air vehicle according to claim 1 wherein the inner and outer structures are arranged such that they can be dismantled from each other.

22. A structural part of an unmanned disposable air vehicle for use as part of a unmanned disposable air vehicle according to claim 1, the structural part having an outer structure and an inner structure located inside the outer structure, the inner structure being arranged to support the outer structure, wherein at least one of the inner structure and outer structure comprises an article of aid such that an air vehicle comprising the structural part may be flown to a relief zone and the structural part dismantled from the air vehicle to allow the article of aid to be used.

23. A method of delivering aid to a relief zone comprising flying an unmanned disposable air vehicle to the relief zone, the unmanned disposable air vehicle having a structural part comprising an article of aid, and dismantling the structural part from the air vehicle to allow the article of aid to be used in the relief zone.

24. A method of delivering aid to a relief zone according to claim 23 wherein the structural part comprises a plurality of articles of aid.

25. A method of delivering aid to a relief zone according to claim 23 wherein the unmanned disposable air vehicle is an unmanned disposable air vehicle comprising a structural part that has an outer structure and an inner structure located inside the outer structure, the inner structure being arranged to support the outer structure, wherein at least one of the inner structure and outer structure comprises an article of aid such that the air vehicle may be flown to a relief zone and the structural part dismantled from the air vehicle to allow the article of aid to be used.

26. (canceled)

27. (canceled)

28. (canceled)

29. A method of assembly of an unmanned disposable air vehicle comprising assembling a structural part of an unmanned disposable air vehicle with a part of an unmanned disposable air vehicle to form an unmanned disposable air vehicle, wherein the structural part has an outer structure and an inner structure located inside the outer structure, the inner structure being arranged to support the outer structure, wherein at least one of the inner structure and outer structure comprises an article of aid such that the air vehicle may be flown to a relief zone and the structural part dismantled from the air vehicle to allow the article of aid to be used.
